(19) United States
(12) Patent Application Publication
(10) Pub. No.: US 2026/0005731 A1
(43) Pub. Date: Jan. 1, 2026

(54) APPARATUS AND METHOD FOR BEAM SEARCHING USING ACTIVE RECONFIGURABLE INTELLIGENT SURFACE IN WIRELESS COMMUNICATION SYSTEM

(71) Applicant: ELECTRONICS AND TELECOMMUNICATIONS RESEARCH INSTITUTE, Daejeon (KR)

(72) Inventor: MANHO PARK, Daejeon (KR)

(21) Appl. No.: 19/242,188

(22) Filed: Jun. 18, 2025

(30) Foreign Application Priority Data
Jun. 26, 2024 (KR) 10-2024-0083596
Mar. 24, 2025 (KR) 10-2025-0037302

(51) Int. Cl. H04B 7/04; H04W 24/08; H04W 64/00

(52) U.S. Cl. CPC H04B 7/04013; H04W 24/08; H04W 64/00

(57) ABSTRACT

Disclosed is an apparatus and method for beam searching using an active reconfigurable intelligent surface in wireless communication systems. An Active Reconfigurable Intelligent Surface (Active RIS) operating method includes: receiving a control command for beam searching from a base station; determining a target RIS beam area according to the control command; setting differential amplification gain for each beam in the target area; processing a search signal received from the base station according to the set differential amplification gain and transmitting to a corresponding beam area; receiving measurement results from the base station; analyzing the measurement results to estimate terminal position and setting a next search target area when additional searching is needed; and relaying communication signals through an RIS beam corresponding to the estimated terminal position. The differential amplification gain includes basic reference gain and differential contrast gain, enabling efficient beam searching with reduced sweeping cycles.

### CROSS REFERENCE TO RELATED APPLICATIONS

This application claims priority to Korean Patent Application No. 10-2024-0083596, filed on Jun. 26, 2024, which claims priority to Korean Patent Application No. 10-2025-0037302, filed on Mar. 24, 2025, the entire contents of which are hereby incorporated by reference.

### BACKGROUND OF THE INVENTION

### 1. Field of the Invention

The present disclosure relates generally to wireless communication systems, and more specifically to an apparatus and method for beam searching using an active reconfigurable intelligent surface in a wireless communication system.

### 2. Description of Related Art

Recently, various technologies have been researched in wireless communication systems to provide high data transmission rates and stable services. Particularly in 5G and beyond systems utilizing ultra-high frequency bands, the directivity and path loss of radio waves increase, making it difficult to secure stable service areas. As a solution to these problems, Reconfigurable Intelligent Surface (RIS) technology has attracted attention.

RIS is a low-complexity application antenna technology that provides a function of controlling the characteristics of received beams according to control information from a base station and delivering them to users using reflectors composed of controllable radio wave elements. This technology has the advantage of having small power consumption and low complexity compared to other types of shadow coverage technologies by simply transmitting communication radio waves that are incident according to control in a specific reflection form.

When radio wave obstacles occur on the radio wave path between a base station and a terminal during wireless communication service, the base station can provide a bypass access path through RIS to overcome radio wave quality degradation or connection disconnection phenomena. RIS, which can adjust reflection characteristics according to base station control signals, can adjust characteristics such as the direction of serviced beams by controlling the reflection characteristics of each RIS element according to settings.

Generally, since RIS is assumed to be composed of passive elements, the directionality and radio wave intensity that RIS can control are determined by the number of elements constituting the RIS. That is, the more elements there are, the more precise radio wave control is possible and signal attenuation is reduced, improving RIS performance. However, to improve the limitations of such passive signal transmission, research on active RIS (Active RIS) that controls signal gain using active elements is being actively conducted. Active RIS can obtain the effect of improving the quality of transmitted signals by processing incident radio waves to improve signal gain.

In beamforming service-based communication systems, an efficient radio wave quality measurement method is required to determine the transmission beam with optimal radio wave environment between base station and terminal or between base station-RIS-terminal. Beamforming service base stations generally transmit base station information and synchronization signals that can be identified for each beam while sweeping beams, and terminals measure these to determine the mutual beam path with the best beam quality.

However, to determine the optimal beam path, measurements must be made for all beam paths, and the results must be comprehensively judged, resulting in enormous system load and service quality degradation due to processing delays. For wireless environment measurement through general search processes, beam sweeping must be repeated as many times as the number of service areas supported by RIS. Also, when supporting multiple RIS, the delay increases according to the number of RIS.

When the beam sweeping delay of a base station supporting M beams is Dsweep and K RIS each service N beams, the total measurement delay becomes K×N×Dsweep. The processing load and delay generated in such RIS services seriously damage overall system efficiency.

### SUMMARY OF THE INVENTION

Based on the discussion as described above, the present disclosure provides an apparatus and method for efficient beam searching using Active Reconfigurable Intelligent Surface (Active RIS) in a wireless communication system.

As described above, accurate wireless channel measurement and management methods are required to provide radio wave shadow elimination services with beam transmission functions. To meet these requirements, the present invention proposes an efficient beam search method with low complexity and delay in an active reflective beam transmission system.

The present disclosure also provides an apparatus and method for minimizing delays occurring in beam searching processes in wireless communication systems.

The present disclosure also provides an apparatus and method for beam searching using differential amplification gain for each beam of active reconfigurable intelligent surfaces in wireless communication systems.

The present disclosure also provides an apparatus and method for performing efficient beam searching while reducing base station (BS) load in wireless communication systems.

The present disclosure also provides an apparatus and method for reducing the number of beam sweeping and improving search efficiency by utilizing binary search methods in wireless communication systems.

According to various embodiments of the present disclosure, a method of operating an Active Reconfigurable Intelligent Surface (Active RIS) for performing beam searching in a wireless communication system includes: receiving a control command for beam searching from a base station (BS); determining a target RIS beam area for searching according to the control command; setting differential amplification gain for each beam in the target RIS beam area for searching; processing a search signal received from the base station according to the set differential amplification gain and transmitting it to the corresponding beam area; receiving measurement results of a terminal from the base station; analyzing the measurement results to estimate the position of the terminal and setting a next search target area when additional searching is needed; and relaying communication signals from the base station through the RIS beam corresponding to the estimated terminal position, wherein the differential amplification gain includes a basic reference gain and a differential contrast gain.

According to various embodiments of the present disclosure, a method of operating a user equipment (UE) for participating in beam searching through an Active Reconfigurable Intelligent Surface (Active RIS) in a wireless communication system includes: initiating channel environment measurement under control of a base station (BS); receiving a search signal from the base station transmitted through the active reconfigurable intelligent surface; measuring quality of the received search signal; and transmitting the measurement results to the base station.

According to various embodiments of the present disclosure, a method of operating a base station (BS) for performing beam searching using an Active Reconfigurable Intelligent Surface (Active RIS) in a wireless communication system includes: initiating a beam search process for quality measurement of wireless environment; transmitting a control command for beam searching to the active reconfigurable intelligent surface; transmitting a search signal including base station information and identification information through a beam connected to the active reconfigurable intelligent surface; forwarding measurement results received from a user equipment (UE) to the active reconfigurable intelligent surface; and providing communication services with the terminal through an optimal beam path determined by the active reconfigurable intelligent surface.

According to various embodiments of the present disclosure, an Active Reconfigurable Intelligent Surface (Active RIS) for performing beam searching in a wireless communication system includes a transceiver and a processor operatively connected to the transceiver, wherein the processor is configured to: receive a control command for beam searching from a base station (BS); determine a target RIS beam area for searching according to the control command and set differential amplification gain for each beam in the target RIS beam area for searching; process a search signal received from the base station according to the set differential amplification gain and transmit it to the corresponding beam area; receive and analyze measurement results of a user equipment (UE) from the base station, estimate the position of the terminal, and set a next search target area when additional searching is needed; and relay communication signals from the base station through the RIS beam corresponding to the estimated terminal position, wherein the differential amplification gain includes a basic reference gain and a differential contrast gain.

The apparatus and method according to various embodiments of the present disclosure enable beam searching to be performed using differential amplification gain of Active Reconfigurable Intelligent Surface (Active RIS), thereby significantly reducing the number of beam sweeping compared to existing methods and improving search efficiency.

The apparatus and method according to various embodiments of the present disclosure enable significant improvement of system efficiency even in environments supporting multiple RIS by introducing binary search methods to reduce beam search delay to log₂(N)+1 times.

The effects obtainable from the present disclosure are not limited to the effects mentioned above, and other effects not mentioned will be clearly understood by those skilled in the art from the description below.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 illustrates a general beam search method according to an embodiment of the present disclosure.

FIG. 2 illustrates a concept of beam transmission service using Active Reconfigurable Intelligent Surface (Active RIS) according to an embodiment of the present disclosure.

FIG. 3 illustrates a processing sequence of a beam search method using Active Reconfigurable Intelligent Surface (Active RIS) according to an embodiment of the present disclosure.

FIG. 4 illustrates a beam search method for providing beam transmission service using Active Reconfigurable Intelligent Surface (Active RIS) with N=4 according to an embodiment of the present disclosure.

FIG. 5 illustrates a flowchart of a beam search method using Active Reconfigurable Intelligent Surface (Active RIS) according to an embodiment of the present disclosure.

FIG. 6 illustrates a flowchart of an operation method of a user equipment (UE) for participating in beam searching through Active Reconfigurable Intelligent Surface (Active RIS) according to an embodiment of the present disclosure.

FIG. 7 illustrates a flowchart of an operation method of a base station (BS) for performing beam searching using Active Reconfigurable Intelligent Surface (Active RIS) according to an embodiment of the present disclosure.

FIG. 8 illustrates a configuration diagram of an Active Reconfigurable Intelligent Surface (Active RIS) device according to an embodiment of the present disclosure.

FIG. 9 illustrates a configuration diagram of a terminal in a wireless communication system according to various embodiments of the present disclosure.

FIG. 10 illustrates a configuration diagram of a base station in a wireless communication system according to various embodiments of the present disclosure.

### DETAILED DESCRIPTION OF THE INVENTION

The terms used in the present disclosure are merely used to describe a particular embodiment, and are not intended to limit the scope of another embodiment. An expression used in the singular encompasses the expression of the plural, unless it has a clearly different meaning in the context. All the terms including technical and scientific terms used herein have the same meaning as commonly understood by those skilled in the art to which the present disclosure belongs. Among the terms used in the present disclosure, the terms defined in a general dictionary may be interpreted to have the meanings the same as or similar to the contextual meanings in the relevant art, and are not to be interpreted to have ideal or excessively formal meanings unless explicitly defined in the present disclosure. In some cases, even the terms defined in the present disclosure should not be interpreted to exclude the embodiments of the present disclosure.

In various embodiments of the present disclosure to be described below, a hardware approach will be described as an example. However, the various embodiments of the present disclosure include a technology using both hardware and software, so the various embodiments of the present disclosure do not exclude a software-based approach.

In addition, in the detailed description and claims of the present disclosure, the expression “at least one of A, B, and C” mean “only A”, “only B”, “only C”, or “any combination of A, B, and C”. In addition, the expression “at least one of A, B, or C” or “at least one of A, B, and/or C” may mean “at least one of A, B, and C”.

The present disclosure relates to an apparatus and method for beam searching using active reconfigurable intelligent surfaces in wireless communication systems. Specifically, the present disclosure describes technology for performing efficient beam searching using differential amplification gain of Active Reconfigurable Intelligent Surface (Active RIS) in wireless communication systems, minimizing the number of beam sweeping through binary search methods, and reducing base station load through RIS-led search processing.

The present disclosure is research conducted with support from the Institute for Information & communications Technology Planning & Evaluation under the Ministry of Science and ICT in 2023 (No.RS-2023-00216221, Development of 5G-Advanced Mobile Communication Service Coverage Extension Technology Based on Intelligent Reconfigurable Antennas).

Terms referring to signals, terms referring to channels, terms referring to control information, terms referring to network entities, and terms referring to device components used in the following description are exemplified for convenience of explanation. Therefore, the present disclosure is not limited to the terms described below, and other terms having equivalent technical meanings may be used.

The present disclosure describes various embodiments using terms used in some communication standards (e.g., 3GPP (3rd Generation Partnership Project)), but this is only an example for explanation. Various embodiments of the present disclosure can be easily modified and applied to other communication systems.

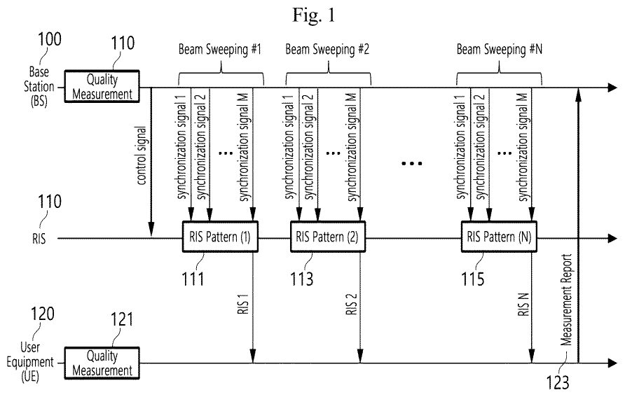

FIG. 1 illustrates a general beam search method according to an embodiment of the present disclosure.

Referring to FIG. 1, a beam search process between a base station (BS) 100, a Reconfigurable Intelligent Surface (RIS) 110, and a user equipment (UE) 120 is shown along a time axis. The base station 100 transmits a quality measurement signal 110. The base station 100 sequentially transmits beams from beam sweeping #1 to beam sweeping #N using a beam sweeping method.

The RIS 110 delivers the quality measurement signal 110 received from the base station 100 to each beam area of RIS pattern (1) 111, RIS pattern (2) 113, . . . , RIS pattern (N) 115. Each RIS pattern includes multiple operation steps such as operation 1, operation 2, . . . , operation M. The RIS 110 relays base station 100 signals according to radio wave characteristics set for each pattern.

The terminal 120 receives and measures signals from the base station 100 transmitted through the RIS 110 through a quality measurement process 121. The terminal 120 measures measurement results (RIS 1, RIS 2, . . . , RIS N) for each beam area and transmits them to the base station 100 as a measurement report 123.

In this general beam search method, measurements must be made sequentially for all beam paths, so when the beam sweeping delay of base station 100 supporting M beams is Dsweep and K RIS 110 each service N beams, the total measurement delay becomes K×N×Dsweep. This method generates considerable system load and delay in environments supporting multiple RIS.

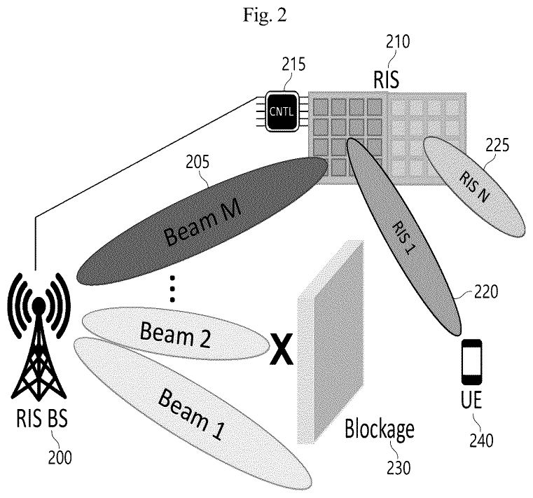

FIG. 2 illustrates a concept of beam transmission service using Active Reconfigurable Intelligent Surface (Active RIS) according to an embodiment of the present disclosure.

Referring to FIG. 2, a communication system composed of a base station (RIS BS) 200, an Active Reconfigurable Intelligent Surface (RIS) 210, an obstacle (Blockage) 230, and a user equipment (UE) 240 is shown.

The base station 200 provides downlink communication services using M beams (Beam 1, Beam 2, . . . , Beam M). The base station 200 can secure connectivity between the base station and RIS through beam M 205 for RIS 210 configured within the service area.

The RIS 210 includes a control unit (CNTL) 215 and can adjust the radio wave characteristics of each element constituting the RIS 210 according to control signals from the base station 200 to deliver signals received from the base station 200 to N directional beam areas (RIS 1, . . . , RIS N) within the RIS.

According to one embodiment, unlike general passive RIS, active RIS 210 can control the gain of individual transmission beams by adjusting the amplification degree of output signals for input signals for each element. Therefore, base station beams transmitted to RIS 210 can be differentially amplified and simultaneously transmitted to multiple RIS beam areas according to all or some RIS element set configuration settings.

That is, beam M 205 transmitted from base station 200 can be transmitted through multiple beams such as RIS beam 1 220 processed by applying radio wave gain a to an element assembly adjusted for transmission direction to beam area 1 through adjustment of radio wave characteristics of RIS 210 elements, and RIS beam N 225 processed by applying radio wave gain b to an element assembly adjusted for transmission direction to beam area N.

The obstacle 230 blocks the direct communication path between the base station 200 and the terminal 240. In particular, Beam 2 from the base station 200 is blocked by the obstacle 230 and cannot reach the terminal 240 through a direct path, as indicated by the X mark.

Such beam transmission service using active RIS enables providing communication services to terminal 240 by bypassing radio wave paths blocked by obstacle 230. In particular, active RIS can improve the quality of transmitted signals through signal amplification functions, unlike passive RIS.

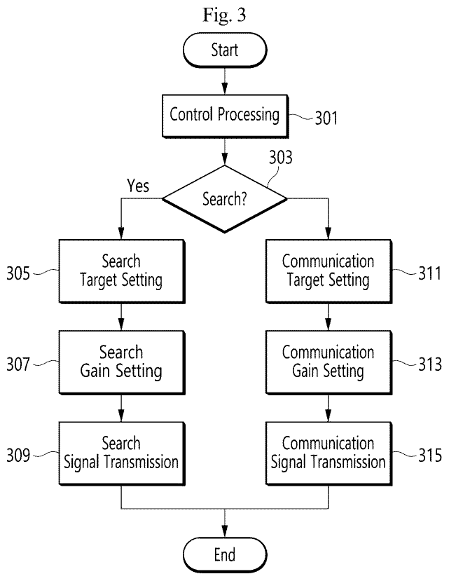

FIG. 3 illustrates a processing sequence of a beam search method using Active Reconfigurable Intelligent Surface (Active RIS) according to an embodiment of the present disclosure.

Referring to FIG. 3, RIS providing communication signal transmission services can perform a control processing step 301 that processes control commands transmitted from the base station. According to one embodiment, control commands may include setting commands related to search, measurement results related to search, control commands related to communication transmission, and other information related to RIS settings.

After the control processing step 301, a search step 303 can be performed to determine whether the control command relates to search processing. If it corresponds to a search-related command (Yes), a search target setting step 305 can be performed to determine the RIS beam area that becomes the target of the search accordingly. In the search target setting step 305, radio wave characteristics for a group of RIS elements can be adjusted so that received beam signals can be transmitted to corresponding beam areas.

Subsequently, a search gain setting step 307 can be performed to set transmission gain for each beam according to the search target gain configuration for the target RIS beam area.

After setting for the target RIS beam is completed, the RIS can perform a search signal transmission step 309 that propagates search signals transmitted from the base station to the set beam area.

Finally, when the search process for candidate RIS beams estimated to be where the terminal is located is completed, the RIS can terminate the search process.

If it is not a search-related command (No), a communication target setting step 311 for communication services is performed. Subsequently, through a communication gain setting step 313 and a communication signal transmission step 315, communication signals transmitted from the base station are propagated to ensure communication connectivity to the terminal.

Subsequently, the RIS can select the RIS beam corresponding to the estimated terminal position according to base station control and propagate communication signals transmitted from the base station through it to ensure communication connectivity to the terminal until the next search process is initiated according to the next control command.

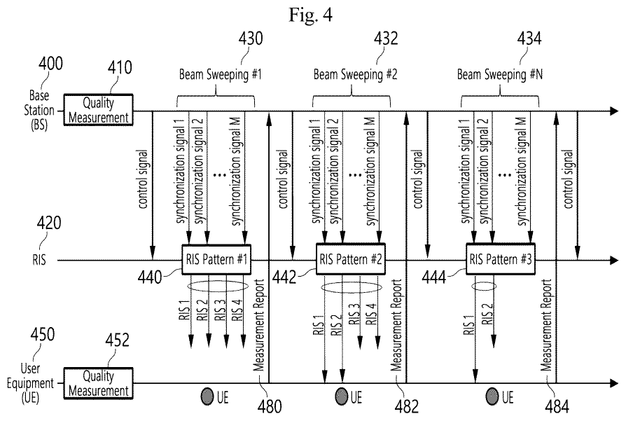

FIG. 4 illustrates a beam search method for providing beam transmission service using Active Reconfigurable Intelligent Surface (Active RIS) according to an embodiment of the present disclosure. Specifically, FIG. 4 shows a case where N=4, but embodiments of the present disclosure are not limited by FIG. 4.

Referring to FIG. 4, a beam search process between a base station 400, RIS 420, and terminal 450 is shown along a time axis. The proposed active RIS-based beam search process according to the example is as follows.

FIG. 4 shows that a base station 400 providing beamforming-based communication services including RIS initiates a process for quality measurement of wireless environment through quality measurement 410 and can transmit corresponding control commands to RIS 420. Terminal 450, assumed to be located in RIS beam area 2, can initiate channel environment measurement through quality measurement 452 according to preset settings or control of base station 400.

RIS 420 that received the quality measurement 410 control signal from base station 400 can set the RIS beam area that becomes the target of the corresponding procedure search. In the case of initial search, the entire RIS beam area can become the search target for the purpose of confirming the location presence of terminal 450 within the corresponding RIS area.

Subsequently, RIS 420 can adjust amplification gain for each beam through active elements through gain configuration for target beam areas. Signal gain transmitted to each area can be differentially applied according to RIS search settings, and in the case of initial search, the gain of each beam can be set equally. The width of differentially applied gain can be assumed to be set larger than the difference in radio wave loss between RIS and terminal based on the RIS service radio wave model.

The example in FIG. 4 can assume that differential contrast gain is greatly amplified compared to basic reference gain. If the opposite case, search detection processing can be applied opposite to the example.

In beam sweeping #1 430, base station 400 can transmit base station information and identification information through beam M connected to RIS 420. RIS 420 can simultaneously propagate received signals by applying a reference gain configuration set for the entire area that RIS is responsible for through RIS pattern #1 440. According to one embodiment, gain setting can apply maximum amplification gain as reference gain when prioritizing search efficiency, or basic amplification gain as reference gain when prioritizing power efficiency.

The example assumes operation prioritizing power efficiency. Terminal 450 located in corresponding RIS beam area 2 can receive this base station identification signal and transmit its measurement report 480 to base station 400. Base station 400 recognizes that terminal 450 is located in the corresponding RIS area through this and can transmit the measurement value to corresponding RIS 420. This wireless quality measurement value can become a reference value for base station transmission signals through corresponding RIS.

When terminal 450 is located in the corresponding RIS area, subsequent searches can proceed with the goal of identifying individual RIS beams where terminal 450 is located. In secondary search, identification targets can be set to the entire RIS beam area where terminal 450 is estimated to be located. Unlike the initial identification process, for beam identification, search gain for beams in individual search areas can be applied to be differentially amplified according to configuration. In the example, assuming the division setting is 2, search target RIS beams are divided by ½, so RIS beams 1 and 2 can be assumed to apply differential contrast gain, and RIS beams 3 and 4 apply basic reference gain. The amplification gain configuration setting for the four beam areas in the example can be set as A(G_contrast, G_contrast, G_reference, G_reference). If the division setting is 4, the gain configuration can be composed of A(G_contrast3, G_contrast2, G_contrast1, G_reference), and accordingly, the number of searches can be reduced.

In beam sweeping #2 432, RIS 420 can process and transmit search signals from base station 400 according to settings through RIS pattern #2 442. Subsequently, measurement report 482 from terminal 450 can be transmitted to RIS 420 through base station 400. RIS 420 can classify the results of this wireless quality measurement based on previously measured reference signal results. When the measurement value corresponds to the result of differential contrast amplification processing, the position of terminal 450 is estimated to be in RIS beam area 1 or 2, and otherwise, the position of terminal 450 can be estimated to be in RIS beam area 3 or 4. RIS 420 can set the corresponding estimated area as the search target area for the next beam sweeping section. In the example, RIS beam areas 1 and 2 can be set as search target areas.

In beam sweeping #3 434, RIS 420 configures differential amplification settings for set search areas as A(G_contrast, G_reference, -, -) through RIS pattern #3 444, so RIS beam 1 applies differential contrast gain and RIS beam 2 applies basic reference gain to transmit base station 400 search signals. Measurement report 484 from terminal 450 is transmitted to RIS 420 through base station 400, and RIS 420 can analyze this wireless quality measurement value. When the measurement value corresponds to a differential contrast value, the position of terminal 450 is determined as RIS beam area 1, and otherwise, the position of terminal 450 can be determined as RIS beam area 2. In the example, RIS beam area 2 can be set as the terminal 450 position. Subsequently, the search process is terminated, and RIS 420 can continuously provide communication services by relaying communication beams transmitted from base station 400 to the set terminal 450 position.

In the case of beam search processes through the proposed method, the number of base station 400 beam sweeping repeated for beam search is reduced to log₂(N)+1 times in the example, resulting in reduced delay effects. In particular, when base station 400 supports multiple RIS 420, the delay caused by beam search is limited to the maximum delay among individual RIS search delays, resulting in significant reduction effects compared to existing methods. That is, when K RIS serving N beam areas are installed in base station 400 serving M beam areas as in the example, the beam search delay performed can be reduced from K×N×Dsweep to {log₂(N)+1}×Dsweep.

The proposed method also enables RIS 420-led search processing rather than existing base station-centralized methods, resulting in significant reduction of base station 400 load effects. Furthermore, the proposed method can be applied using current search-related interfaces and procedures, minimizing impact on standards.

Such delay reduction and load reduction enable providing rapid and stable communication services to users who experience wireless connection failures due to radio wave blocking. Furthermore, when base station 400 installs multiple RIS 420 within service areas and configures multiple RIS beam areas for service, it can enable efficient and stable service provision by securing communication service reliability by limiting maximum delay.

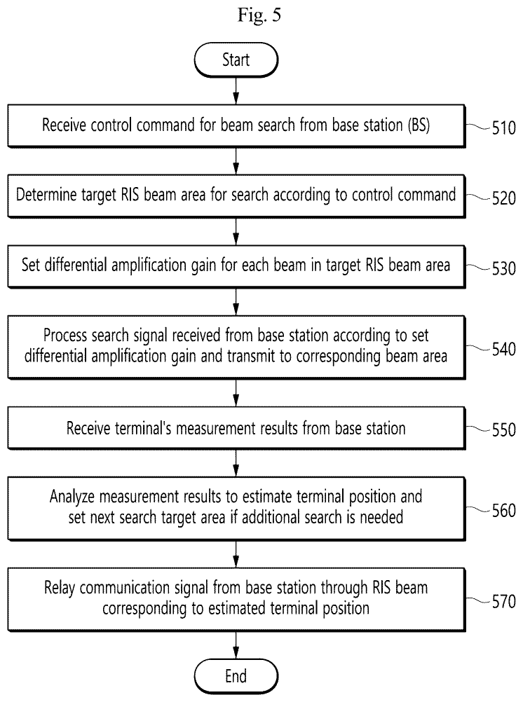

FIG. 5 illustrates a flowchart of a beam search method using Active Reconfigurable Intelligent Surface (Active RIS) according to an embodiment of the present disclosure.

Referring to FIG. 5, in step 510, the Active Reconfigurable Intelligent Surface (Active RIS) can receive a control command for beam searching from a base station (BS). According to one embodiment, the control command may include setting commands related to search, measurement results related to search, control commands related to communication transmission, and other information related to RIS settings.

In step 520, the active reconfigurable intelligent surface can determine the target RIS beam area for searching according to the control command. In the case of initial search, the entire RIS beam area can become the search target for the purpose of confirming the location presence of terminals within the corresponding RIS area. In subsequent searches, only areas estimated to be where terminals are located based on previous measurement results can be set as search targets.

In step 530, the active reconfigurable intelligent surface can set differential amplification gain for each beam in the target RIS beam area for searching. Signal gain transmitted to each area can be differentially applied according to RIS search settings, and in the case of initial search, the gain of each beam can be set equally. In subsequent searches, differential contrast gain can be applied to some beams and basic reference gain can be applied to other beams to more accurately determine terminal positions.

In step 540, the active reconfigurable intelligent surface can process search signals received from the base station according to set differential amplification gain and transmit them to corresponding beam areas. In step 540, RIS can adjust radio wave characteristics of each element to propagate signals received from the base station in set beam directions.

In step 550, the active reconfigurable intelligent surface can receive measurement results of terminals from the base station. Terminals receive search signals from base stations transmitted through RIS, measure their quality, and transmit results to base stations, and base stations can transmit these measurement results to RIS.

In step 560, the active reconfigurable intelligent surface can analyze measurement results to estimate terminal positions and set next search target areas when additional searching is needed. When measurement values correspond to result values by differential contrast gain, it can be estimated that terminals are located in RIS beam areas where differential contrast gain is applied. Conversely, when measurement values correspond to result values by basic reference gain, it can be estimated that terminals are located in RIS beam areas where basic reference gain is applied.

In step 570, the active reconfigurable intelligent surface can relay communication signals from base stations through RIS beams corresponding to estimated terminal positions. Through this, rapid and stable communication services can be provided even to users who experience wireless connection failures due to radio wave blocking.

This beam search method can reduce delays by reducing the number of base station beam sweeping repeated for beam search to log₂(N)+1 times. Also, when base stations support multiple RIS, delays caused by beam search are limited to maximum delays among individual RIS search delays, resulting in significant reduction effects compared to existing methods.

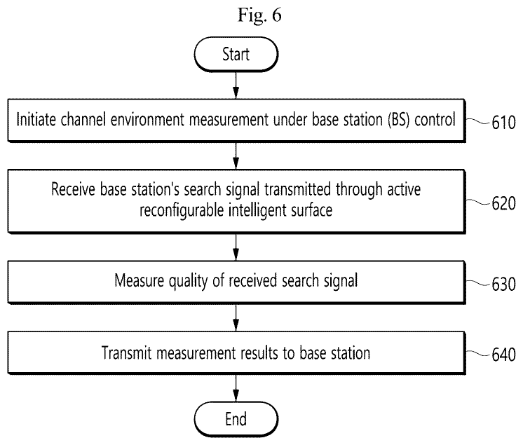

FIG. 6 illustrates a flowchart of an operation method of a user equipment (UE) for participating in beam searching through Active Reconfigurable Intelligent Surface (Active RIS) according to an embodiment of the present disclosure.

Referring to FIG. 6, in step 610, terminals can initiate channel environment measurement under control of base stations (BS). In step 610, terminals can receive control signals for channel environment measurement directly from base stations or indirectly through RIS. Base stations can instruct terminals to perform measurements at specific times or specific beam sweeping sections.

In step 620, terminals can receive search signals from base stations transmitted through active reconfigurable intelligent surfaces. According to one embodiment, search signals can be transmitted with differential amplification gain applied for each beam area of RIS. Terminals can receive signals transmitted from various directions according to beam patterns set by RIS, which can have different characteristics for each beam sweeping section.

In step 630, terminals can measure quality of received search signals. Terminals can measure parameters such as Received Signal Strength Indicator (RSSI), Reference Signal Received Power (RSRP), or Signal to Interference plus Noise Ratio (SINR). According to one embodiment, measurements can be performed for each beam sweeping section, and terminals can measure signal quality for each RIS beam area separately.

In step 640, terminals can transmit measurement results to base stations. Terminals can transmit measurement results for each beam sweeping section individually or comprehensively to base stations. According to one embodiment, measurement results can be used by base stations to transmit to RIS for estimating terminal positions and determining optimal beam paths.

Subsequently, terminals can receive communication services through optimal beam paths determined by base stations and RIS. When RIS beam areas where terminals are located are determined, RIS can relay communication signals from base stations to terminals through corresponding beams to provide stable communication connections.

Through this beam search method, terminals can receive communication services using bypass paths through RIS even in environments where direct communication with base stations is impossible. In particular, even in situations where direct communication is impossible due to radio wave obstacles, high-quality communication services can be provided through beam transmission functions of RIS.

The terminal beam search participation method shown in FIG. 6 shows detailed operations on the terminal side in the active RIS-based beam search process described in FIG. 4, and can contribute to efficient beam search and communication path establishment by operating as part of the overall beam search system.

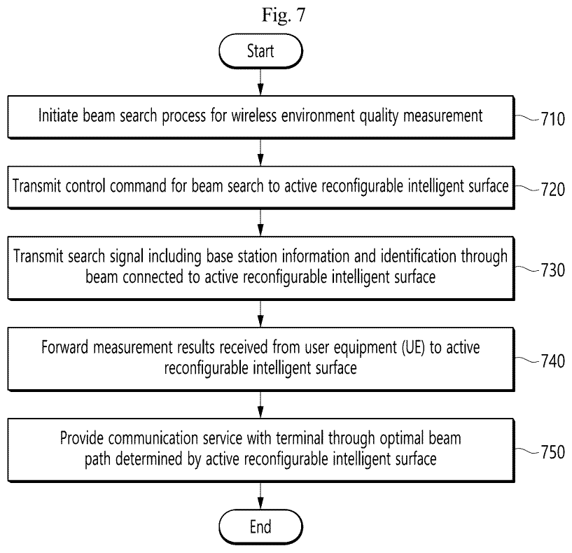

FIG. 7 illustrates a flowchart of an operation method of a base station (BS) for performing beam searching using Active Reconfigurable Intelligent Surface (Active RIS) according to an embodiment of the present disclosure.

Referring to FIG. 7, in step 710, base stations can initiate beam search processes for quality measurement of wireless environments. In step 710, base stations can check communication quality with terminals located within service areas and start beam searching to secure bypass paths through RIS for terminals where direct communication is difficult due to radio wave obstacles. Base stations can transmit control messages notifying the start of beam searching to other entities in the network.

In step 720, base stations can transmit control commands for beam searching to active reconfigurable intelligent surfaces. According to one embodiment, control commands may include information about setting commands related to search, search methods, target RIS beam areas for search, differential amplification gain setting methods, and beam sweeping section settings. Base stations can transmit customized control commands to each RIS when multiple RIS exist in the network.

In step 730, base stations can transmit search signals including base station information and identification information through beams connected to active reconfigurable intelligent surfaces. Base stations transmit search signals through specific beams (e.g., beam M) for communication with RIS, and search signals can be retransmitted in various directions through RIS. Search signals may include base station identifiers, beam indices, synchronization information, and may also include reference signals that allow terminals to measure signal quality.

In step 740, base stations can forward measurement results received from user equipment (UE) to active reconfigurable intelligent surfaces. Terminals receive search signals from base stations transmitted through RIS, measure their quality, and transmit results to base stations, and base stations can transmit these measurement results to corresponding RIS. According to one embodiment, measurement results may include information such as received signal strength, reference signal received power, and signal to interference plus noise ratio.

In step 750, base stations can provide communication services with terminals through optimal beam paths determined by active reconfigurable intelligent surfaces. When RIS analyzes measurement results to estimate terminal positions and determines optimal RIS beams, base stations can provide communication services such as data, voice, and video to terminals through corresponding RIS beams. Through this, stable services can be provided even to terminals where direct path communication is difficult.

This beam search method can significantly reduce the number of beam sweeping by using efficient searching through differential amplification gain of RIS, unlike existing sequential measurement methods for all beam paths. In particular, when base stations support multiple RIS, delays caused by beam search are limited to maximum delays among individual RIS search delays, resulting in significant reduction effects compared to existing methods.

This beam search method also enables RIS-led search processing rather than existing base station-centralized methods, resulting in significant reduction of base station load effects. Base stations perform intermediary roles of transmitting measurement results to RIS, and actual terminal position estimation and optimal beam determination are performed by RIS, reducing computational load on base stations.

The base station beam search method shown in FIG. 7 shows detailed operations on the base station side in the active RIS-based beam search process described in FIG. 4, and can contribute to efficient beam search and communication path establishment by configuring the overall beam search system together with the RIS operation method of FIG. 5 and the terminal operation method of FIG. 6.

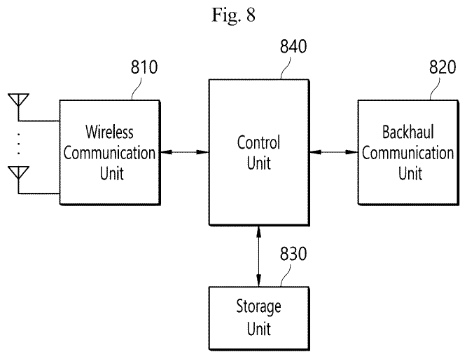

FIG. 8 illustrates a functional configuration of a reconfigurable intelligent surface (RIS) in a wireless communication system according to various embodiments of the present disclosure. According to one embodiment, FIG. 8 can be understood as a functional configuration of an RIS controller included in RIS. The configuration illustrated in FIG. 8 can be understood as a configuration of RIS. Terms such as ‘. . . unit’, ‘. . . device’, etc. used below mean units that process at least one function or operation, which can be implemented as hardware, software, or a combination of hardware and software.

Referring to FIG. 8, RIS may include a wireless communication unit 810, a backhaul communication unit 820, a storage unit 830, and a control unit 840. The wireless communication unit 810 performs functions for transmitting and receiving signals through wireless channels. For example, the wireless communication unit 810 performs conversion functions between baseband signals and bit streams according to physical layer specifications of the system. For example, during data transmission, the wireless communication unit 810 generates complex symbols by encoding and modulating transmission bit streams. Also, during data reception, the wireless communication unit 810 restores received bit streams through demodulation and decoding of baseband signals. Also, the wireless communication unit 810 up-converts baseband signals to radio frequency (RF) band signals and transmits them through antennas, and down-converts RF band signals received through antennas to baseband signals. The wireless communication unit 810 of RIS can receive signals from base stations and transmit received signals by reflecting them to terminals. Also, the wireless communication unit 810 of RIS can receive signals from terminals and transmit received signals by reflecting them to base stations. At this time, RIS can reflect received signals as they are, or transmit signals generated based on information of received signals through the wireless communication unit 810. According to one embodiment, RIS can adjust RIS reflection patterns based on control signals received from base stations and reflect received signals based on adjusted RIS reflection patterns.

For this purpose, the wireless communication unit 810 may include transmission filters, reception filters, amplifiers, mixers, oscillators, digital to analog convertors (DAC), analog to digital convertors (ADC), etc. Also, the wireless communication unit 810 may include multiple transmission/reception paths. Furthermore, the wireless communication unit 810 may include at least one antenna array composed of multiple antenna elements. From a hardware perspective, the wireless communication unit 810 may be composed of digital units and analog units, and analog units may be composed of multiple sub-units according to operating power, operating frequency, etc.

Also, the wireless communication unit 810 may include multiple reflection elements (RE). Based on multiple REs, the wireless communication unit 810 can reflect signals. When reflecting, amplitude and phase of received signals can be adjusted by specific values. Combinations of amplitude and phase of signals to be adjusted by specific values may be referred to as reflection patterns. According to one embodiment, signal reflection based on various reflection patterns may include functions substantially identical or similar to beamforming of base stations.

The wireless communication unit 810 can transmit and receive signals. For this purpose, the wireless communication unit 810 may include at least one transceiver. For example, the wireless communication unit 810 can transmit synchronization signals, reference signals, system information, messages, control information, or data. Also, the wireless communication unit 810 can perform beamforming.

The wireless communication unit 810 transmits and receives signals as described above. Accordingly, all or part of the wireless communication unit 810 may be referred to as a ‘transmitter’, ‘receiver’, or ‘transceiver’. Also, in the following description, transmission and reception performed through wireless channels are used in the meaning of including processing as described above by the wireless communication unit 810.

The backhaul communication unit 820 provides interfaces for performing communication with other nodes in the network. That is, the backhaul communication unit 820 converts bit streams transmitted from RIS to other nodes, for example, other access nodes, base stations, upper nodes, core networks, etc., into physical signals, and converts physical signals received from other nodes into bit streams. According to one embodiment, RIS can receive setting information about reflection patterns and reflection pattern periods from base stations through the backhaul communication unit 820.

The storage unit 830 stores data such as basic programs, application programs, and setting information for RIS operation. The storage unit 830 may include memory. The storage unit 830 may be composed of volatile memory, non-volatile memory, or a combination of volatile memory and non-volatile memory. The storage unit 830 provides stored data according to requests from the control unit 840. According to one embodiment, the storage unit 830 can pre-store information about multiple reflection patterns applied to RIS (i.e., RIS beambook).

The control unit 840 controls overall operations of RIS. For example, the control unit 840 transmits and receives signals through the wireless communication unit 810 or through the backhaul communication unit 820. Also, the control unit 840 records and reads data in the storage unit 830. The control unit 840 can perform functions of protocol stacks required by communication standards. For this purpose, the control unit 840 may include at least one processor.

The configuration of RIS shown in FIG. 8 is only an example of RIS, and examples of base stations performing various embodiments of the present disclosure are not limited by the configuration shown in FIG. 8. That is, according to various embodiments, some configurations may be added, deleted, or changed.

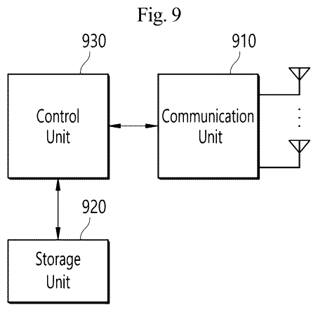

FIG. 9 illustrates a configuration diagram of a terminal in a wireless communication system according to various embodiments of the present disclosure. The configuration illustrated in FIG. 9 can be understood as a configuration of a terminal. Terms such as ‘. . . unit’, ‘. . . device’, etc. used below mean units that process at least one function or operation, which can be implemented as hardware, software, or a combination of hardware and software.

Referring to FIG. 9, terminals may include a communication unit 910, a storage unit 920, and a control unit 930.

The communication unit 910 can perform functions for transmitting and receiving signals through wireless channels. For example, the communication unit 910 can perform conversion functions between baseband signals and bit streams according to physical layer specifications of the system. For example, during data transmission, the communication unit 910 can generate complex symbols by encoding and modulating transmission bit streams. During data reception, the communication unit 910 can restore received bit streams through demodulation and decoding of baseband signals. Also, the communication unit 910 can up-convert baseband signals to RF band signals and transmit them through antennas, and down-convert RF band signals received through antennas to baseband signals. For example, the communication unit 910 may include transmission filters, reception filters, amplifiers, mixers, oscillators, DACs, ADCs, etc.

Also, the communication unit 910 may include multiple transmission/reception paths. Furthermore, the communication unit 910 may include at least one antenna array composed of multiple antenna elements. From a hardware perspective, the communication unit 910 may be composed of digital circuits and analog circuits (e.g., radio frequency integrated circuits (RFIC)). Here, digital circuits and analog circuits may be implemented as one package. Also, the communication unit 910 may include multiple RF chains. Furthermore, the communication unit 910 can perform beamforming.

The communication unit 910 transmits and receives signals as described above. Accordingly, all or part of the communication unit 910 may be referred to as a ‘transmitter’, ‘receiver’, or ‘transceiver’. Also, in the following description, transmission and reception performed through wireless channels may be used in the meaning of including processing as described above by the communication unit 910.

The storage unit 920 can store data such as basic programs, application programs, and setting information for terminal operation. The storage unit 920 may be composed of volatile memory, non-volatile memory, or a combination of volatile memory and non-volatile memory. The storage unit 920 can provide stored data according to requests from the control unit 930.

The control unit 930 can control overall operations of terminals. For example, the control unit 930 can transmit and receive signals through the communication unit 910. Also, the control unit 930 can record and read data in the storage unit 920. The control unit 930 can perform functions of protocol stacks required by communication standards. For this purpose, the control unit 930 may include at least one processor or microprocessor, or may be part of a processor. Also, part of the communication unit 910 and the control unit 930 may be referred to as a communication processor (CP).

According to various embodiments, the control unit 930 can perform operations for participating in beam searching through Active Reconfigurable Intelligent Surface (Active RIS). For example, the control unit 930 can perform operations of initiating channel environment measurement under base station control, receiving search signals from base stations transmitted through active reconfigurable intelligent surfaces, measuring quality of received search signals, and transmitting measurement results to base stations. Through this, terminals can receive communication services using bypass paths through RIS even in environments where direct communication with base stations is impossible.

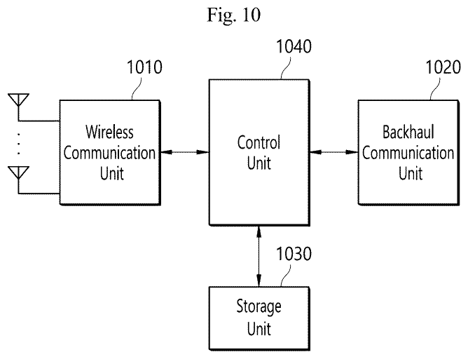

FIG. 10 illustrates a configuration diagram of a base station in a wireless communication system according to various embodiments of the present disclosure. The configuration illustrated in FIG. 10 can be understood as a configuration of a base station. Terms such as ‘. . . unit’, ‘. . . device’, etc. used below mean units that process at least one function or operation, which can be implemented as hardware, software, or a combination of hardware and software.

Referring to FIG. 10, base stations may include a wireless communication unit 1010, a backhaul communication unit 1020, a storage unit 1030, and a control unit 1040.

The wireless communication unit 1010 can transmit and receive wireless signals through wireless channels. For example, the wireless communication unit 1010 can perform conversion functions between baseband signals and bit streams according to physical layer specifications of the system. Also, when transmitting data, the wireless communication unit 1010 can generate complex symbols by encoding and modulating transmission bit streams. When receiving data, the wireless communication unit 1010 can restore received bit streams through demodulation and decoding of baseband signals.

The wireless communication unit 1010 can up-convert baseband signals to radio frequency (RF) band signals and transmit them through antennas, and down-convert RF band signals received through antennas to baseband signals. For this purpose, the wireless communication unit 1010 may include transmission filters, reception filters, amplifiers, mixers, oscillators, digital to analog convertors (DAC), and analog to digital convertors (ADC).

The wireless communication unit 1010 may include multiple transmission/reception paths, and the wireless communication unit 1010 may include at least one antenna array composed of multiple antenna elements.

From a hardware perspective, the wireless communication unit 1010 may include digital units and analog units, and analog units may include multiple sub-units according to operating power, operating frequency, etc. Digital units may be implemented with at least one processor (e.g., digital signal processor (DSP)).

The wireless communication unit 1010 can transmit and receive wireless signals as described above. Accordingly, all or part of the wireless communication unit 1010 may be referred to as a ‘transmitter’, ‘receiver’, or ‘transceiver’. Also, in the following description, transmission and reception performed through wireless channels may include processing as described above by the wireless communication unit 1010.

The backhaul communication unit 1020 can provide interfaces for performing communication with other nodes in the network. That is, the backhaul communication unit 1020 can convert bit streams transmitted from base stations to other nodes, for example, other access nodes, other base stations, upper nodes, and core networks, into physical signals, and convert physical signals received from other nodes into bit streams.

The storage unit 1030 can store data such as basic programs, application programs, and setting information for base station operation. The storage unit 1030 may be composed of volatile memory, non-volatile memory, or a combination of volatile memory and non-volatile memory. The storage unit 1030 can provide stored data according to requests from the control unit 1040.

The control unit 1040 can control overall operations of base stations. For example, the control unit 1040 can transmit and receive signals through the wireless communication unit 1010 or through the backhaul communication unit 1020. Also, the control unit 1040 can record and read data in the storage unit 1030. Also, the control unit 1040 can perform functions of protocol stacks required by communication standards. For this purpose, the control unit 1040 may include at least one processor.

According to various embodiments of the present disclosure, the control unit 1040 can control operations for performing beam searching using Active Reconfigurable Intelligent Surface (Active RIS). For example, the control unit 1040 can perform control to initiate beam search processes for quality measurement of wireless environments, transmit control commands for beam searching to active reconfigurable intelligent surfaces, transmit search signals including base station information and identification information through beams connected to active reconfigurable intelligent surfaces, forward measurement results received from terminals to active reconfigurable intelligent surfaces, and provide communication services with terminals through optimal beam paths determined by active reconfigurable intelligent surfaces.

Methods according to embodiments described in claims or specifications of the present disclosure may be implemented in the form of hardware, software, or a combination of hardware and software.

When implemented in software, computer-readable storage media storing one or more programs (software modules) may be provided. One or more programs stored in computer-readable storage media are configured for execution by one or more processors within electronic devices. One or more programs include instructions that cause electronic devices to execute methods according to embodiments described in claims or specifications of the present disclosure.

Such programs (software modules, software) may be stored in random access memory, non-volatile memory including flash memory, read only memory (ROM), electrically erasable programmable read only memory (EEPROM), magnetic disc storage devices, compact disc-ROM (CD-ROM), digital versatile discs (DVDs) or other forms of optical storage devices, magnetic cassettes. Or they may be stored in memory composed of combinations of some or all of these. Also, each configuration memory may be included in multiple numbers.

Also, programs may be stored in attachable storage devices that can be accessed through communication networks such as Internet, Intranet, local area network (LAN), wide area network (WAN), or storage area network (SAN), or combinations thereof. Such storage devices can connect to devices performing embodiments of the present disclosure through external ports. Also, separate storage devices on communication networks may connect to devices performing embodiments of the present disclosure.

In the specific embodiments of the present disclosure described above, components included in the disclosure are expressed in singular or plural according to presented specific embodiments. However, singular or plural expressions are selected appropriately for situations presented for convenience of explanation, and the present disclosure is not limited to singular or plural components. Components expressed in plural may be configured in singular, or components expressed in singular may be configured in plural.

Meanwhile, although specific embodiments have been described in the detailed description of the present disclosure, various modifications are possible within the scope that does not depart from the present disclosure. Therefore, the scope of the present disclosure should not be limited to described embodiments but should be determined by the scope of claims described below as well as equivalents to this scope of claims.

What is claimed is:

1. A method performed by an Active Reconfigurable Intelligent Surface (Active RIS) for performing beam searching in a wireless communication system, comprising:
receiving a control command for beam searching from a base station (BS);
determining a target RIS beam area for searching according to the control command;
setting differential amplification gain for each beam in the target RIS beam area for searching;
processing a search signal received from the base station according to the set differential amplification gain and transmitting the search signal to a corresponding beam area;
receiving measurement results of a terminal from the base station;
analyzing the measurement results to estimate a position of the terminal and setting a next search target area when additional searching is needed; and
relaying communication signals from the base station through an RIS beam corresponding to the estimated terminal position,
wherein the differential amplification gain includes a basic reference gain and a differential contrast gain.

2. The method of claim 1, wherein setting the differential amplification gain comprises:
applying identical reference gain to an entire target RIS beam area for searching during initial searching.

3. The method of claim 1, wherein setting the differential amplification gain comprises:
dividing the target RIS beam area for searching, applying differential contrast gain to a first group, and applying basic reference gain to a second group.

4. The method of claim 1, wherein estimating the position of the terminal comprises:
when the measurement results correspond to result values by differential contrast gain, estimating that the terminal is located in an RIS beam area where differential contrast gain is applied.

5. The method of claim 1, further comprising:
dividing the target RIS beam area for searching using a binary search method to estimate the position of the terminal.

6. A method performed by a user equipment (UE) for participating in beam searching through an Active Reconfigurable Intelligent Surface (Active RIS) in a wireless communication system, comprising:
initiating channel environment measurement under control of a base station (BS);
receiving a search signal from the base station transmitted through the active reconfigurable intelligent surface;
measuring quality of the received search signal; and
transmitting measurement results to the base station.

7. The method of claim 6, wherein measuring the quality of the search signal comprises:
measuring at least one of Received Signal Strength Indicator (RSSI), Reference Signal Received Power (RSRP), or Signal to Interference plus Noise Ratio (SINR).

8. The method of claim 6, wherein transmitting the measurement results to the base station comprises:
transmitting measured results for each of a plurality of beam sweeping sections to the base station.

9. The method of claim 6, further comprising:
receiving communication services from the base station through an optimal beam path via the active reconfigurable intelligent surface.

10. The method of claim 6, wherein the terminal is located in a beam area of the active reconfigurable intelligent surface and is in a state where direct communication with the base station is impossible.

11. A method performed by a base station (BS) for performing beam searching using an Active Reconfigurable Intelligent Surface (Active RIS) in a wireless communication system, comprising:
initiating a beam search process for quality measurement of a wireless environment;
transmitting a control command for beam searching to the active reconfigurable intelligent surface;
transmitting a search signal including base station information and identification information through a beam connected to the active reconfigurable intelligent surface;
forwarding measurement results received from a user equipment (UE) to the active reconfigurable intelligent surface; and
providing communication services with the terminal through an optimal beam path determined by the active reconfigurable intelligent surface.

12. The method of claim 11, wherein the control command includes information about target RIS beam area setting for searching, differential amplification gain setting, and beam sweeping section setting.

13. The method of claim 11, wherein initiating the beam search process is performed to secure a bypass access path through the active reconfigurable intelligent surface when direct communication with the terminal is impossible.

14. The method of claim 11, further comprising:
simultaneously performing beam searching for a plurality of active reconfigurable intelligent surfaces,
wherein total beam search delay is limited to a maximum delay among search delays of individual active reconfigurable intelligent surfaces.

15. The method of claim 11, further comprising:
transmitting additional search signals when additional searching is needed after forwarding the measurement results of the terminal to the active reconfigurable intelligent surface.
